(19) United States
(12) Patent Application Publication
(10) Pub. No.: US 2008/0082744 A1
(43) Pub. Date: Apr. 3, 2008

(54) STORAGE SYSTEM HAVING DATA COMPARISON FUNCTION

(76) Inventor: Yutaka NAKAGAWA, Yokohama (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/565,864

(22) Filed: Dec. 1, 2006

(30) Foreign Application Priority Data
Sep. 29, 2006 (JP) 2006-266604

(51) Int. Cl. G06F 13/00

(52) U.S. Cl. 711/113

(57) ABSTRACT

Before writing a first data from a host device to a storage device, a second data stored in a write destination location on the storage device is read and compared with the first data, and if they match, the first data is not written in the storage device.

### CROSS-REFERENCE TO PRIOR APPLICATION

This application relates to and claims the benefit of priority from Japanese Patent Application No. 2006-266604, filed on Sep. 29, 2006, the entire disclosure of which is incorporated herein by reference.

### BACKGROUND

The present invention relates to a storage system.

Storage systems using RAID (Redundant Arrays of Inexpensive Disks) technology, which increase the speed of processing for a read/write request from a host by operating a plurality of storage devices in parallel, and improves reliability by redundant configuration, has been developed. In Non-patent Document (D. Patterson, et al: “A case for Redundant Arrays of Inexpensive Disks (RAID)”, Proceedings of the 1988 ACM SIGMOD International Conference on Management of Data, pp. 109-116, 1998), five types of RAID configurations from RAID 1 to RAID 5 are described in detail. In addition to the five types of RAID configurations, such configurations as RAID 0 and RAID 6 exist, and these configurations are selectively used according to the application.

Conventionally a storage device called HDD (Hard Disk Drive), which is a type of magnetic storage device, has been generally used for the storage device of the above mentioned storage system.

Other than the above mentioned HDD, a storage device using a storage medium called a flash memory, which is a type of non-volatile semiconductor memory, also exists. Recently a flash memory medium using a storage medium called a NAND type flash memory, of which capacity is increasing and price per unit capacity is decreasing, is used for general computer equipment.

Unlike HDD, a flash memory does not require time for moving a magnetic head, so overhead time required for data access can be decreased, and response performance can be improved compared with HDD.

However each storage element of the flash memory has a limitation in erase count (guaranteed count) for overwriting data. Japanese Patent No. 3407317 discloses a technology on a storage device for decreasing the polarization of erase processing execution counts by managing the erase count in each erasing unit of the flash memory and writing data in an area of which erase count is low in a storage area of which erase count is high, so as to suppress the deterioration of the flash memory.

By using the technology disclosed in Japanese Patent No. 3407317, polarization of the erase processing execution count in each storage element can be decreased, so that the time when the erase count reaches a guaranteed count can be delayed. However if this technology is used for a storage system having a flash memory, it is possible that many I/Os are generated in the storage system, and the erase count reaches the guaranteed count (that is life runs out) in a short time, and this flash memory must be replaced. Such a problem also occurs when a storage system has another type of storage device of which write count or erase count has limitation.

A feature of a flash memory is that write performance is poor (e.g. slow) compared to the read performance (e.g. speed). Other storage devices having this feature could possibly exist.

### SUMMARY

With the foregoing in view, it is an object of the present invention to extend the life of a storage device installed in a storage system when the storage device has limitation in write count or erase count.

It is another object of the present invention to improve write performance of a storage device installed in a storage system when write performance thereof is poor compared with the read performance.

A storage system of the present invention has a cache area and a data comparator, and a controller of the storage system executes the following processing. The controller writes a first data according to a write request received from a host device in a cache area, read a second data from a write destination location in the storage device according to the write request, and writes the read second data in the cache area. The data comparator compares the first data and the second data written in the cache area. The controller does not write the first data in the storage device if the first data and second data match as a result of the comparison, and writes the first data on the cache area in the storage device if the first data and second data do not match.

The cache area can be created in a memory, for example. The controller and data comparator can be constructed by hardware, a computer program or combination thereof (e.g. a part is implemented by a computer program and the rest is implemented by hardware) respectively. The computer program is read and executed by a predetermined processor. A memory area on a hardware resource, such as a memory, may be used for the information processing performed by the computer program being read by the processor. The computer program may be installed from a recordable medium, such as a CD-ROM, to the computer, or may be downloaded to the computer via a communication network.

### BRIEF DESCRIPTION OF THE DRAWINGS

FIG. 1 is a diagram depicting a general configuration of the storage system;

FIG. 2 is a flow chart depicting an example of the first compare-write processing according to Embodiment 1;

FIG. 3 is a flow chart depicting an example of the second compare-write processing according to Embodiment 1;

FIG. 4 is a flow chart depicting an example of the third compare-write processing according to Embodiment 1;

FIG. 5 is a flow chart depicting the entire write processing when a device not executing compare-write processing exists;

FIG. 6 shows a configuration example of a table for managing the executability setting of compare-write processing;

FIG. 7 shows a user interface screen for setting the executability of compare-write processing;

FIG. 8 is a diagram depicting the data structure of the RAID 5 configuration;

FIG. 9 is a flow chart depicting the write processing in the RAID 5 configuration;

FIG. 10 is a flow chart depicting the first compare-write processing in the RAID 5 configuration according to Embodiment 2;

FIG. 11 is a diagram depicting a general configuration of the storage system according to Embodiment 3; and

FIG. 12 is a diagram depicting the compare-write processing in the RAID 1 configuration according to Embodiment 2.

### DESCRIPTION OF THE PREFERRED EMBODIMENTS

As examples of embodiments of the present invention, the first to third embodiments will now be described.

### Embodiment 1

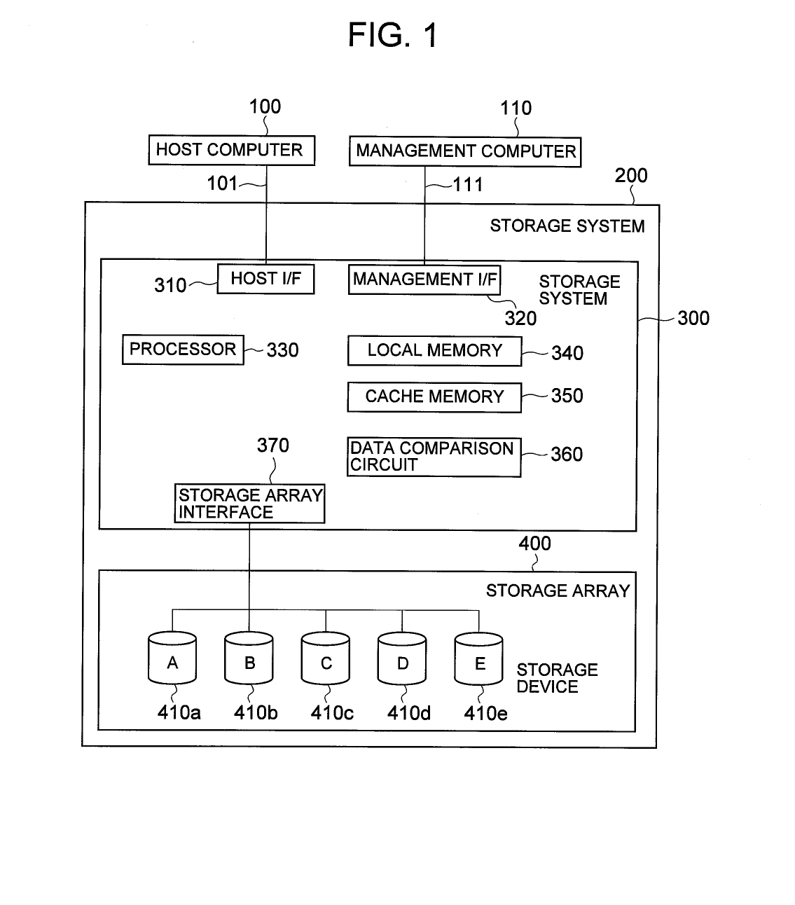

Embodiment 1 of the present invention will be described with reference to FIG. 1 to FIG. 7.

FIG. 1 shows a configuration example of the storage system.

This storage system 200 can be connected with one or a plurality of host computer 100 via a network 101. If necessary, the storage system 200 can be connected with one or a plurality of management computers 110 via a network 111. The network 101 can be SAN (Storage Area Network), for example. The network 111 can be LAN (Local Area Network), for example. The networks 101 and 111 need not be separate networks.

The host computer 100 is a computer device constructed as a work station, main frame or a personal computer, for example. The host computer 100 accesses the storage system 200 and reads/writes data.

The management computer 110 is a computer device which accesses the storage system 200 and manages the storage system 200. The management computer 110 and the host computer 100 may be the same computer devices.

The storage system 200 can roughly be divided into a storage controller 300 and a storage array 400.

The storage controller 300 can be comprised of a host interface 310, a management interface 320, a processor 330, a local memory 340, a cache memory 350, a data comparison circuit 360 and a storage array interface 370. The storage controller 300 can be one or a plurality of circuit boards, for example.

The host interface 310 is an interface for performing communication between the host computer 100 and storage system 200. The management interface 320 is an interface for performing communication between the management computer 110 and storage system 200. The storage array interface 370 is an interface for performing communication between the storage controller 300 and storage array 400.

The processor 330 controls communication between the host computer 100 and storage system 200, controls communication between the management computer 110 and storage system 200, controls communication between the storage controller 300 and storage array 400, and executes various programs stored in the local memory 340.

The local memory 340 stores various programs to be executed by the processor 330, and stores data required for controlling the storage system 200. The programs to be executed by the processor 330 include programs for implementing the later mentioned compare-write of data.

The cache memory 350 plays a role of a data buffer which temporarily stores data to be transferred from the host computer 100, management computer 110 or storage array 400 to the storage controller 300, or stores data required for controlling the storage system 200.

The data comparison circuit 360 is a circuit for judging whether two data match or mismatch in the later mentioned data compare-write processing. In the description of the embodiment, the data comparison circuit 360 is implemented as hardware, but may be implemented as a program which is stored in the local memory 340 and is executed by the processor 330.

The storage array 400 can be comprised of one or a plurality of storage device 410. The storage device 410 is, for example, a flash memory, hard disk drive, optical disk, a magneto-optical disk, and a magnetic tape, but is not especially restricted to any device. A plurality of types of storage devices may coexist in the storage array.

When the storage system 200 received a write request from the host computer 100, the compare-write processing is executed. Now some compare-write processing will be described. In the following description, a case of storing data, of which write is requested, in the storage device 410a (device A in FIG. 1) will be considered. Here a write target data of the write request from the host computer 100 is called “new data”, and data already written in a storage destination address (address in the storage device 410a) of the new data is called “old data”.

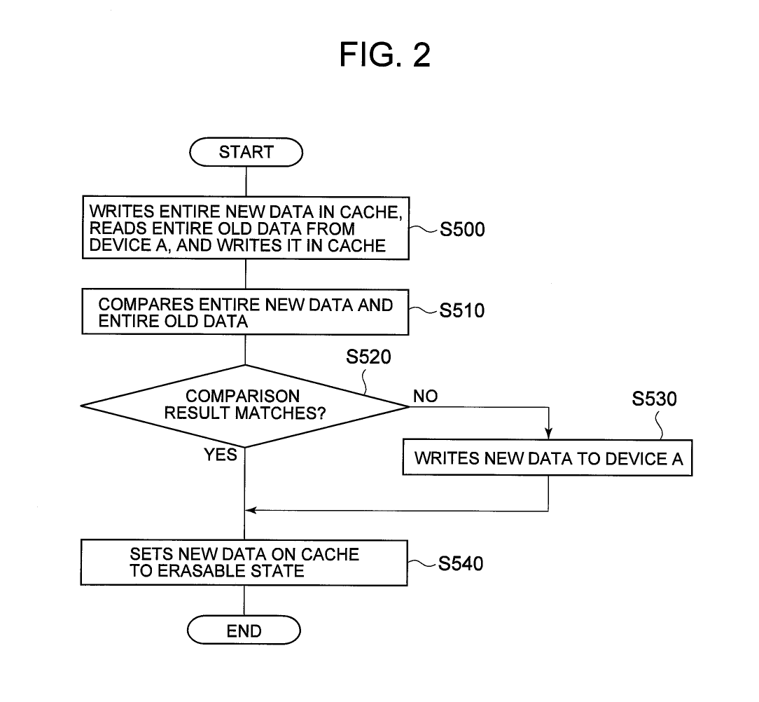

FIG. 2 shows an example of the flow of the first compare-write processing. In FIG. 2, “step” is abbreviated by “S”.

In the first compare-write processing, the entire new data and entire old data, not a part, are compared. In the following description, the data as a whole may be expressed as “entire data”.

First, in step 500, the processor 330, which reads and executes a predetermined computer program, writes an entire new data according to a received write request in a cache memory 350, reads an entire old data from the storage device 410a, and writes the entire old data in the cache memory 350. Specifically, for example, the processor 330 specifies the above mentioned storage destination address from the write destination information specified by the received write request, and reads the entire old data from the specified storage destination address.

Then in step 510, the data comparison circuit 360 compares the entire new data and the entire old data on the cache memory 350. In this case, for example, the processor 330 may set the respective write locations of the new data and old data on the cache memory 350 in the data comparison circuit 360, so that the data comparison circuit 360 reads the entire new data and the entire old data from the setting address of the timing of this setting, and these data are compared. Or the respective write locations of the new data and old data on the cache memory 350 may be predetermined so that the data comparison circuit 360 reads the new data and old data from the predetermined locations.

In step 520, if the comparison result in step 510 is a match, processing advances to step 540. This is because it is unnecessary to write the entire new data, since the entire old data, of which contents are the same as the entire new data, already exists in the storage destination address. In step 540, the processor 330 sets the new data on the cache memory 350 to an erasable state, for example, and ends the compare-write processing. The erasable state means a data management state wherein writing of other data to the storage area of this data is enabled by clearing the overwrite inhibit flag, for example.

In step 520, if the comparison result in step 510 is a mismatch, processing advances to step 530. This is because the entire new data must be written to the storage destination address. In step 530, the processor 330 writes the new data in the storage device 410a, and then processing advances to step 540.

Possible units of comparing data in step 510 are one data when the entire new data divided into one or more data, a multiple of a minimum write unit (minimum data size of one write execution) of the storage device 410a, a multiple of a minimum read unit (minimum data size of one read execution) of the storage device 410a, and a multiple of a minimum erase unit (minimum data size of one erase execution) of the storage device 410a, for example.

In the first compare-write processing described with reference to FIG. 2, the entire new data and entire old data are compared, but in the second compare-write processing to be described next, data is partially compared first, then the entire data is compared.

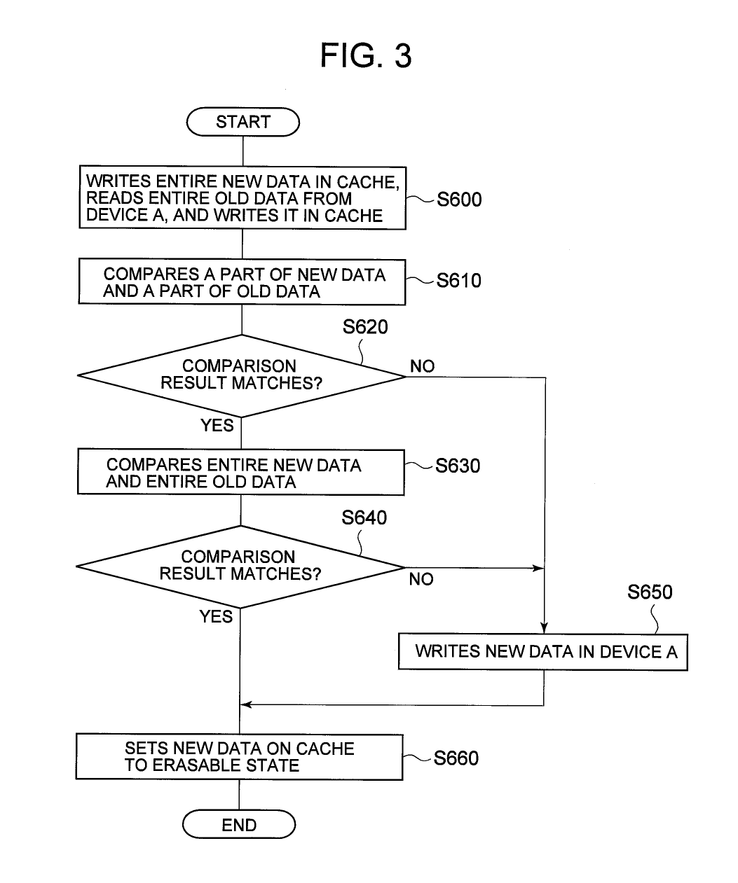

FIG. 3 shows an example of a flow of the second compare-write processing. Herein below, differences from the first compare-write processing will primarily be described, and description on redundant aspects will be omitted or simplified.

In step 600, the processor 330 writes new data in the cache memory 350, and reads old data from the storage device 410a, and writes it in the cache memory 350.

Then in step 610, the data comparison circuit 360 compares a part of the new data and a part of the old data. Here the parts of the data to be compared are portions of data which exist in a same location of the respective entire data. For example, if a part of the new data is a portion of the new data which exists from the beginning to a predetermined position, a part of the old data to be compared with this is also a portion of the old data which exists from the beginning to the predetermined position. The comparison target position will be described later.

In step 620, if the partial data comparison result in step 610 is a mismatch, processing advances to step 650. In other words, the processor 330 writes the entire new data in the storage device 410a. Then processing advances to step 660.

In step 620, if the partial data comparison result in step 610 is a match, processing advances to step 630. In other words, the data comparison circuit 360 compares the entire new data and the entire old data (the remaining part of data which was not compared may be compared).

In step 640, if the entire data comparison result is a match in step 630, processing advances to step 650. In other words, the processor 330 writes the new data in the storage device 410a. Then processing advances to step 660.

In step 640, if the entire data comparison result is a mismatch in step 630, processing advances to step 660.

In step 660, just like step 540, the processor 330 sets the new data on the cache memory 350 to the erasable state, and ends compare-write processing.

The comparison target position described in step 610 may be a data integrity code shown in Japanese Patent Application Laid-Open No. 2001-202295, a first part of the write data, end of the write data, or an arbitrary location of the write data.

The above mentioned second compare-write processing in FIG. 3 has a partial data comparison processing which is not included in the first compare-write processing in FIG. 2. By this, when data must be updated to the new data, representative data can be compared, so the necessity of an update (that is necessity to write the new data in the storage device 410a) can be judged without waiting for comparing the entire data. Therefore the second compare-write processing is effective when the data volume that can be compared within a predetermined time is limited.

In the second compare-write processing in FIG. 3, the entire old data is read from the storage device 410 at the point when partial data comparison (step 610) is performed, but in the third compare-write processing, the entire old data may be read when comparison of the entire data becomes necessary.

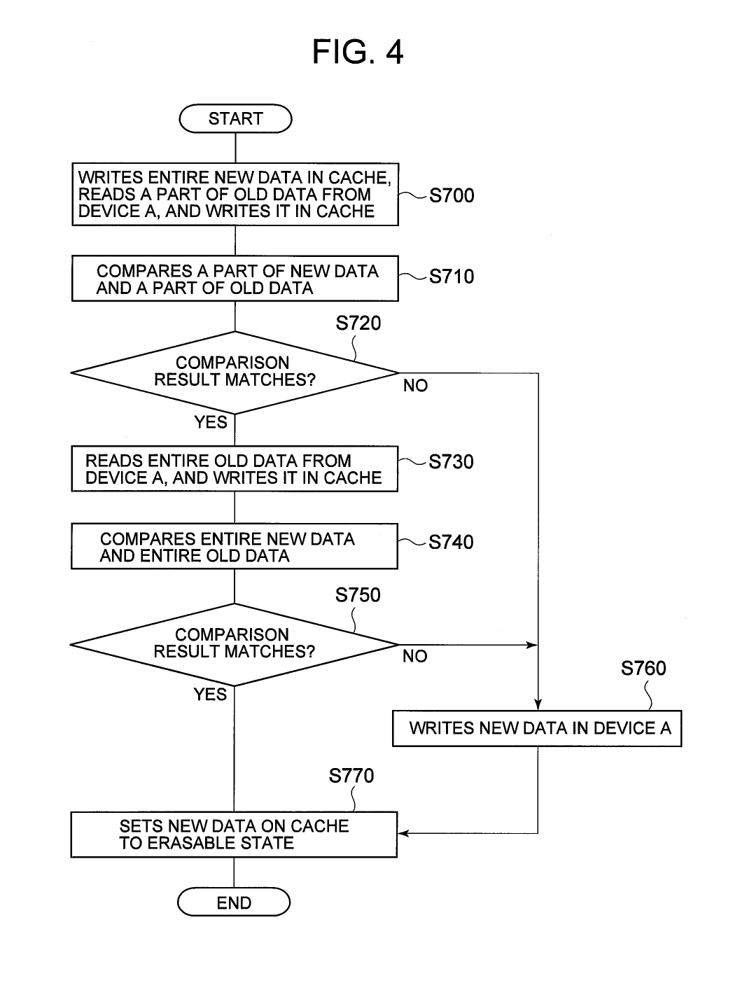

FIG. 4 shows an example of the flow of the third compare-write processing.

First in step 700, the processor 330 writes the new data to the cache memory 350, and reads a part of the old data (partial data comparison target position) from the storage device 410a, and writes it to the cache memory 350.

Then in step 710, the data comparison circuit 360 compares a part of the new data and the same part of the old data (that is a part of the old data which was read).

In step 720, if the partial data comparison result in step 710 is a mismatch, processing advances to step 760. In other words, the processor 330 writes the new data in the storage device 410a. Then processing advances to step 770.

In step 720, if the partial data comparison result in step 710 is a match, processing advances to step 730. In other words, the processor 330 reads the entire old data of the write target area (entire old data which exists in the range where the entire new data is scheduled to be written) from the storage device 410a, and writes it in the cache memory 350. Then processing advances to step 740. In other words, the data comparison circuit 360 compares the entire new data and the entire old data.

In step 750, if the entire data comparison result is a mismatch in step 740, processing advances to step 760. In other words, the processor 330 writes the new data in the storage device 410a. Then processing advances to step 770.

In step 750, if the entire data comparison result in step 740 is a match, processing advances to step 770.

In step 770, just like step 540, the processor 330 sets the new data on the cache memory 350 to erasable state, and ends compare-write processing.

In the case of the third compare-write processing shown in FIG. 4, the volume of the old data to be read from the storage device 410a when the partial data comparison result mismatches is less compared with the compare-write processing in FIG. 3. As a result, the time required for preparation for comparison processing when data must be updated to new data can be decreased. Therefore the third compare-write processing is effective when the data update volume is high.

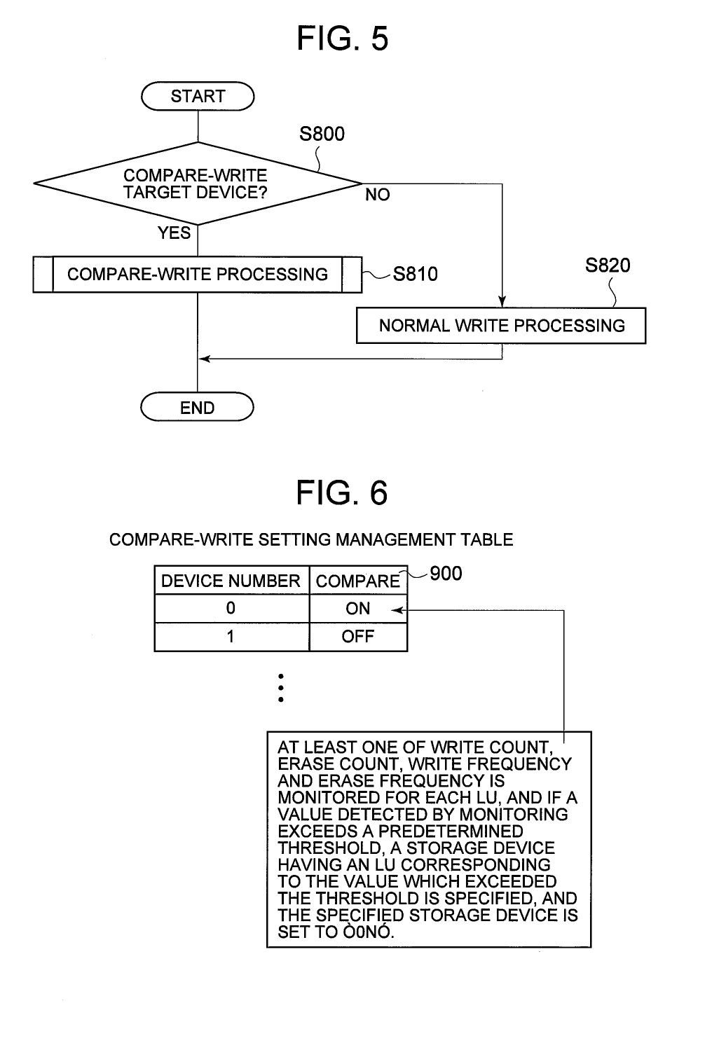

This compare-write processing can be applied to the entire storage area in the storage array 400, but may be applied only to a part thereof. In this case, if the host computer 100 sends a write request to the storage system 200, the processor 330 refers to a later mentioned compare-write setting management table 900, for example, and judges whether the write target device is a compare target device (step 800), as shown in FIG. 5. If it is a compare target in step 800, one of the above mentioned first to third compare-write processings is executed (step 810), and if not, the compare-write processing is not executed, in other word, normal write processing is executed (step 820).

FIG. 6 shows a configuration example of the compare-write setting management table 900.

In the compare-write setting management table 900, information on whether compare-write processing is executed or not is stored for each predetermined unit. Examples of the predetermined unit are storage system unit, logical device (LU) unit, physical device unit, and each type of storage device 410. The logical device is a logical storage device, which is set using the storage space of one or a plurality of storage devices 410, and is also called a “logical volume” or “logical unit”.

The setting values of the compare-write setting management table 900 can be changed by the processor 330 according to the internal state of the storage system 200, such as write count to the storage device 410, or can be changed by a user using the management computer 110, as mentioned later.

Specifically, for example, the processor 330 monitors at least one of write count, erase count, write frequency (write count per unit time) and erase frequency (erase count per unit time) for each LU. If a value acquired by monitoring exceeds a predetermined threshold, the processor 330 specifies a storage device having an LU of which value exceeded the threshold (by, for example, referring to a table in which correspondence of LU and storage device is recorded), and sets compare of the specified storage device to “ON”.

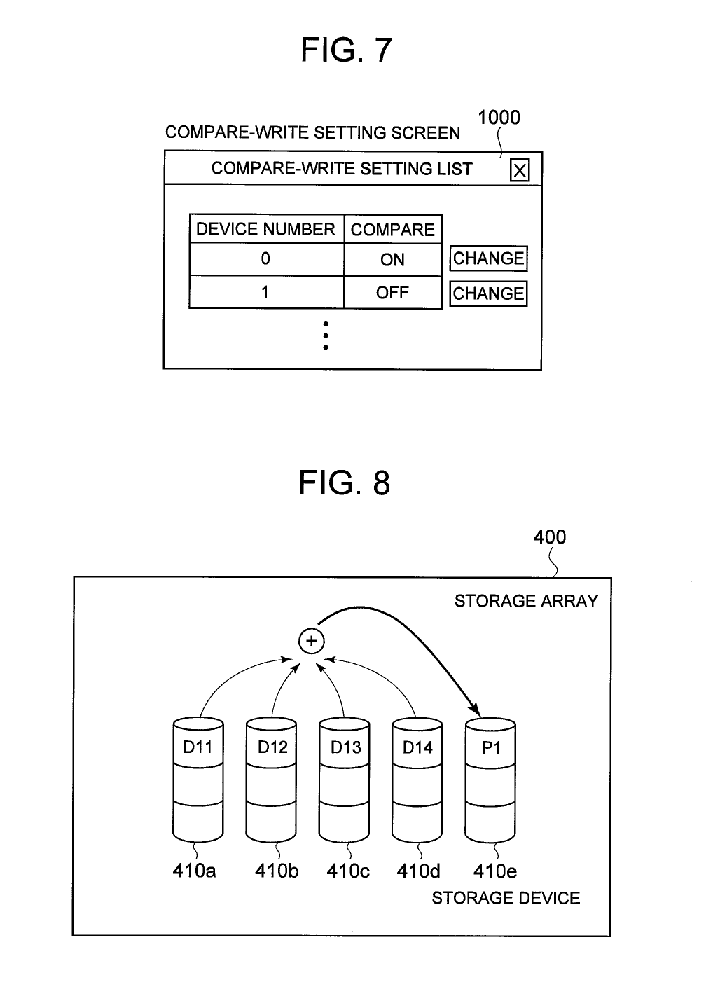

FIG. 7 shows a screen for the user to change a value of the compare-write setting management table 900 using the management computer 110.

On this screen, setting values are displayed for each unit of managing the executability of the compare-write processing, and the setting can be changed. The executability of the compare-write processing can be set, not limited by a graphical interface, but also by another interface, such as a command line interface.

The present embodiment, which is configured as in the above description, can suppress the write count in the storage device. Therefore in a storage system constructed with a storage device of which write count has limitation, the life of the storage device can be extended. Also in a storage system constructed with a storage device of which performance is poorer compared with the read performance, the write performance can be improved.

### Embodiment 2

Now Embodiment 2 of the present invention will be described with reference to FIG. 8 to FIG. 10. The present embodiment is a variant form of Embodiment 1, so description of the configuration overlapping with the above mentioned configuration is omitted or simplified, and difference will be primarily described. In the present embodiment, a case when storage data is made redundant among a plurality of storage devices 410 using RAID technology will be described.

FIG. 8 shows a configuration of RAID 5 to be used for description of Embodiment 2. First the general processing is described, then a method of using the compare-write processing of the present invention will be described.

Here a case of the 4D+1P configuration using five storage devices, 410a to 410e (in other words, a RAID group comprised of five data storage devices in RAID 5), will be considered. In a data group for generating a certain parity, data to be stored in the storage device 410a is called D11, data to be stored in the storage device 410b is called D12, data to be stored in the storage device 410c is called D13, data to be stored in the storage device 410d is called D14, and parity to be stored in the storage device 410e is called P1. At this time, P1=D11 XOR D12 XOR D13 XOR D14 is established. XOR indicates exclusive OR.

In this state, if D11 is updated to D11′, P1 also must be updated to P1′, and can be calculated based on P1′=D11 XOR D11′ XOR P1.

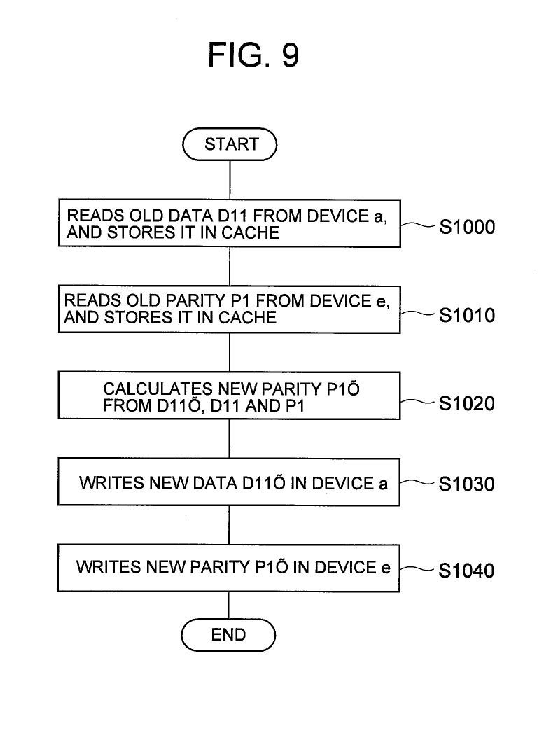

FIG. 9 shows this processing. First in step 1000, the processor 330 reads data D11 (old data D11) stored in the storage device 410a, and stores it in the cache memory 350. Then in step 1010, the processor 330 reads a parity P1 (old parity P1) stored in the storage device 410b, and stores it in the cache memory 350. Then in step 1020, the processor 330 calculates a new parity P1′, using the old data D11 and the new data D11′ and old parity P1. Then the processor 330 writes the new data D11′ in the storage device 410a in step 1030, and writes the new parity P1′ in the storage device 410e in step 1040. The timing to execute step 1050 is arbitrary, such as before step 1000 or between step 1000 and step 1010.

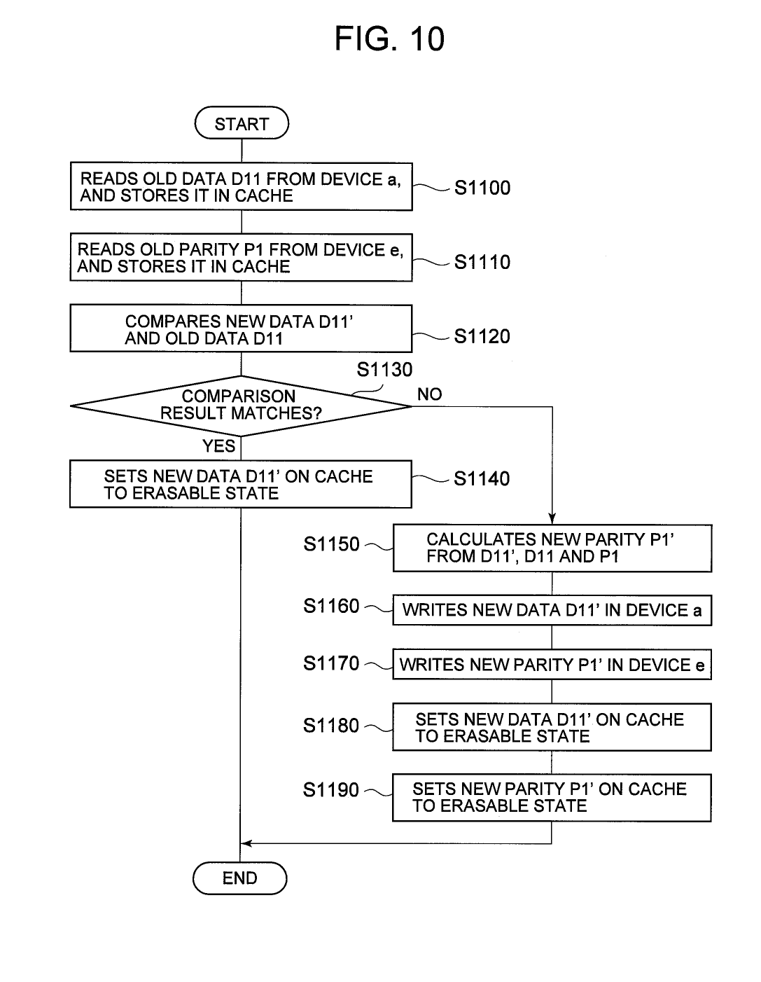

Now the first compare-write processing according to the second embodiment will be described with reference to FIG. 10.

First in step 1100, the processor 330 writes the new data D11′ to the cache memory 350, and read data D11 (old data D11) stored in the storage device 410a, and writes it in the cache memory 350.

Then in step 1110, the processor 330 reads a parity P1 (old parity P1) stored in the storage device 410b, and writes it in the cache memory 350.

Then in step 1120, the data comparison circuit 360 compares the new data D11′ and the old data D11.

If the judgment result in step 1130 is a match, processing advances to step 1140 since the data in the storage device 410a is not updated. In other words, the processor 330 sets the new data D11′ on the cache memory 350 to erasable state.

If the judgment result in step 1130 is a mismatch, processing advances to step 1150. In other words, the processor 330 calculates a new parity P1′ using the old data D11, new data D11′ and old parity P1. Then the processor 330 performs processing of writing the new data D11′ in the storage device 410a (step 1160), processing of writing the new parity P1′ in the data storage device 410e (step 1170), processing to set the new data D11′ on the cache memory 350 to erasable state (step 1180), and processing to set the new parity P1′ on the cache memory 350 to erasable state (step 1190), and ends compare-write processing.

For the four steps from step 1160 to step 1190, the sequence can be changed only if the data on the cache memory 350 is set to erasable state after performing processing to write the new data D11′.

For the timing to read the parity in step 1110, any timing can be used only if it is before calculating the new parity P1′ in step 1150, and the parity need not be read if the comparison result in step 1130 is a match.

In the above example, RAID 5 was used for description, but the present invention can also be constructed using another RAID level which generates a parity and error correction codes from the data, and stores them.

If identical data is written in a plurality of storage devices 410, such as the case of RAID 1, it is also possible that in a step of comparing data in Embodiment 1, each data is not compared but the old data is read from one of the storage devices 410 storing the copied data, and is compared with the new data, so that read count and comparison count of the old data are decreased.

In Embodiment 2, the case of comparing the entire new data and entire old data was shown, but it is also possible to construct such that partial data comparison is performed first, then entire data is compared, as shown in Embodiment 1.

The present embodiment, which has the above configuration, can exhibit not only the same effect as Embodiment 1, but also can decrease overhead applied to compare-write processing using a RAID configuration.

### Embodiment 3

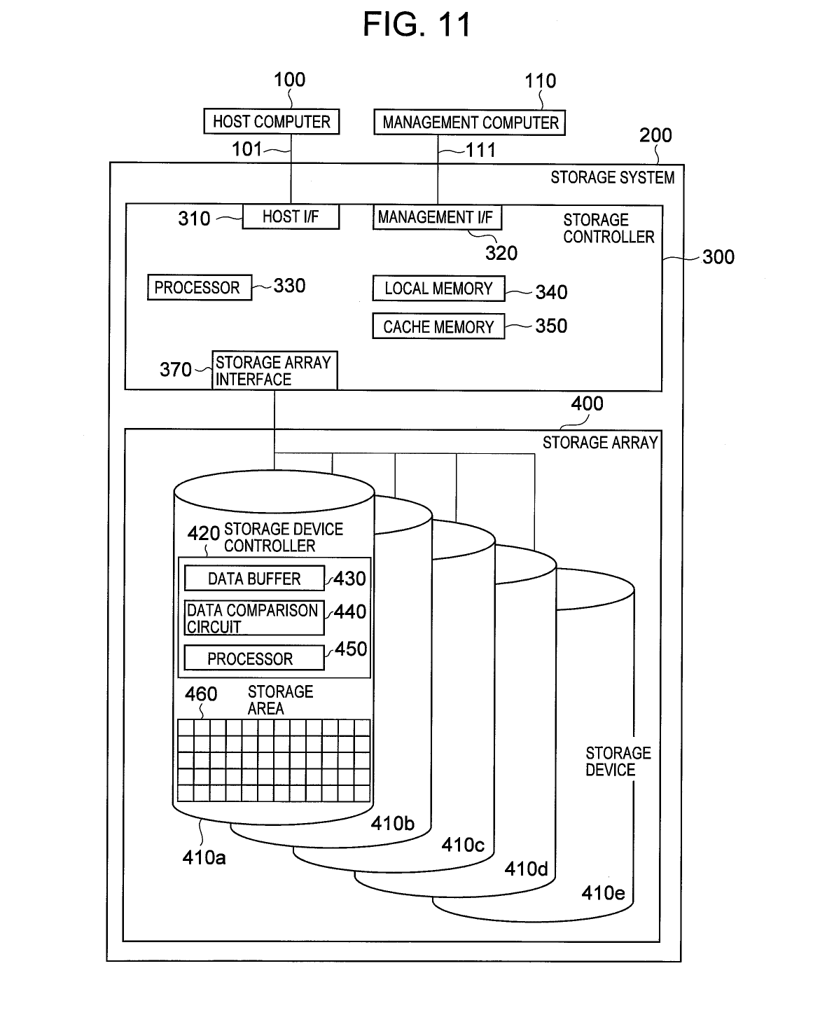

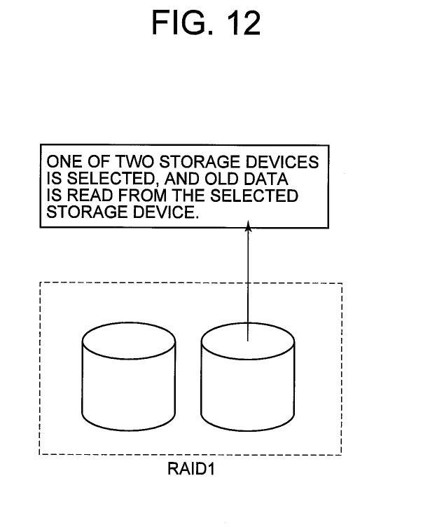

Embodiment 3 of the present invention will now be described with reference to FIG. 11. The present embodiment is a variant form of Embodiment 1 and Embodiment 2, so description of the configuration overlapping with the above mentioned configurations is omitted or simplified, and difference will be primarily described. In the present embodiment, a case when new data and old data are compared by the storage array will be described.

FIG. 11 shows a configuration example of the storage system according to Embodiment 3. The difference from FIG. 1 is that the data comparison circuit 360 is not in the storage controller 300, and that a device having an embedded data buffer 430, data comparison circuit 440 and processor 450 is used as the storage device 410.

In the present embodiment, reading the old data from the storage device 410 and comparison of the new data and old data, which are performed by the storage controller 300 in Embodiment 1, are performed by a storage device controller 420 in the storage device 410. In other words, after the processor 450 reads the old data from the storage area 460 to the data buffer 430, data is compared using the data comparison circuit 440, and is written to the storage area 460 if necessary based on the comparison result.

If a storage device 410, which can set executability of compare-write processing for the entire storage device 410 or for each predetermined unit of the storage area 460 in the storage device 410, is used, executability can be set from the storage controller 300 for the storage device 410 according to the setting from the management computer 110 or the access frequency of the storage device 410.

Also a RAID configuration may be formed among the storage areas 460. Specifically, for example, a RAID configuration may be formed among the storage areas 460 if (1) the storage device 410a is a unit of replacing a failed part of the storage system, or (2) the storage area 460 is a replacement unit.

In the present embodiment, which is constructed as the above description, the storage controller 300 need not read old data or compare new data and old data every time the storage device 410 is written to, so load on the storage controller 300 is shifted to the storage array 400.

The present invention is not limited to the above mentioned embodiments. Experts in the art could add and change in various ways within the scope of the invention. For example, the storage controller may comprise a plurality of first controllers (e.g. controller boards) for controlling communication with a host device (e.g. host computer or another storage system 1), a plurality of second controllers (e.g. controller boards) for controlling communication with a storage device, a cache memory for storing data exchanged between the host device and storage device, a control memory for storing data for controlling the storage system, and a connector (e.g. switch such as a cross bar switch) for connecting the first controller, second controller, cache memory and control memory respectively. In this case, one or both of the first controller and second controller can perform processing as the storage controller. Here the data comparison circuit may exist in any of the first controller, second controller and connector. The above mentioned processing executed by the processor 330 may be performed either by a processor installed in the first controller or a processor installed in the second controller. A control memory is not essential, and an area for storing information which could be stored by the control memory may be created in the cache memory instead.

What is claimed is:

1. A storage system which has a storage device and receives a write request sent from a host device and stores data according to the write request in the storage device, comprising:
a cache area;
a controller for writing a first data according to a write request received from the host device in the cache area, reading a second data from a write destination location in the storage device according to the received write request, and writing the read second data in the cache area; and
a data comparator for comparing the first data and the second data written in the cache area, wherein
the controller does not write the first data to the storage device if the first data and the second data match as a result of the comparison, and writes the first data that is on the cache area in the storage device if the first data and the second data do not match.

2. The storage system according to claim 1, wherein
the data comparator compares a part of the first data and a part of the second data, and if the part of the first data and the part of the second data match, the data comparator compares the remaining parts, and
the controller writes the first data in the storage device if the result of the comparison of the parts, or the result of the comparison of the remaining parts is a mismatch.

3. The storage system according to claim 1, wherein
the controller reads a part of the second data from the write destination location, and writes a part of the second data to the cache area,
the data comparator compares a part of the first data written in the cache area and a part of the second data written in the cache area, and
the controller writes the first data in the storage device if the part of the first data written in the cache area and the part of the second data written in the cache area mismatch.

4. The storage system according to claim 3, wherein
the controller reads the remaining part of the second data from the storage device and writes the same in the cache area if the result of the comparison is a match,
the data comparator compares the remaining part of the first data and the remaining part of the second data, and
the controller does not write the first data in the storage device if the remaining part of the first data and the remaining part of the second data match, and writes the first data in the storage device if the remaining part of the first data and the remaining part of the second data mismatch.

5. The storage system according to claim 3, wherein the data size of a part of the second data to be read from the storage device is not less than a minimum data size required for the comparison, and is a unit of reading of the storage device.

6. The storage system according to claim 1, wherein
the controller is constructed such that redundant data is generated based on data according to the write request, and the data and the redundant data are written in the storage device,
the data comparator compares the first data and the second data, and does not compare a first redundant data which is a redundant data of the first data and a second redundant data which is a redundant data of the second data, and
the controller does not write the first data and the first redundant data if the comparison result match, and writes the first data and the first redundant data in the storage device if the comparison result mismatch.

7. The storage system according to claim 6, wherein
the data comparator compares a part of the first data and a part of the second data, and if the part of the first data and the part of the second data match, the data comparator compares the remaining parts, and
the controller writes the first data and the first redundant data in the storage device if the result of the comparison of the parts or the result of comparison of the remaining parts is a mismatch.

8. The storage system according to claim 6, wherein
a plurality of the storage devices exist, the plurality of storage devices constitute a RAID group, a RAID level of the RAID group is a RAID level which requires generation of parity data, and the redundant data is the parity data.

9. The storage system according to claim 6, wherein the redundant data is an error correction code.

10. The storage system according to claim 1, wherein
a plurality of the storage devices exist, and the control section is constructed so that mirroring processing, to multiplex and write data in the plurality of storage devices, is performed, and if the write request is received, the control section selects one storage device out of the plurality of storage devices, and reads the second data from the write destination location in the selected storage device.

11. The storage system according to claim 1, wherein
a unit of the data to be compared is one of the following (1) to (4):
(1) size of one data when the first data is divided into one or more data;
(2) a multiple of minimum data size required for writing;
(3) a multiple of minimum data size required for reading; and
(4) a multiple of minimum erase size.

12. The storage system according to claim 1, wherein the control section writes only a part of the first data which does not match the second data in the storage device as a result of the comparison.

13. The storage system according to claim 1, further comprises a control unit for receiving a write request from the host device and writing data in the storage device, wherein the cache area, the controller and the data comparator are installed in the storage device.

14. The storage system according to claim 1, wherein the storage device is a flash memory device.

15. The storage system according to claim 1, wherein a plurality of the storage devices exist, and the plurality of storage devices are a plurality of storage areas in one storage device.

16. The storage system according to claim 1, wherein a plurality of the storage devices exist, and the controller reads the second data from the write destination location if the write destination location is a storage device requiring write suppression out of the plurality of storage devices, and writes the first data in the write destination location without reading the second data if not.

17. The storage system according to claim 16, wherein the storage device requiring the write suppression is a storage device in which at least one of write count, erase count, write frequency and erase frequency is a predetermined value or more.

18. A storage control method, comprising the steps of:
receiving a write request sent from a host device;
writing a first data according to the received write request in a cache area;
reading a second data from a write destination location in a storage device according to the received write request;
writing the read second data in the cache area;
comparing the first data and the second data written in the cache area; and
not writing the first data in the storage device if the first data and the second data match as a result of the comparison, and writing the first data that is on the cache memory in the storage device if the first data and the second data do not match.
